(19) United States
(12) Patent Application Publication
(10) Pub. No.: US 2017/0058434 A1
(43) Pub. Date: Mar. 2, 2017

(54) Support Disk with a Crowned Running Surface

(71) Applicant: Maschinenfabrik Rieter AG, Winterthur (CH)

(72) Inventors: Manfred Knabel, Ingolstadt (DE); Roland Eberhardt, Renningen (DE); Matthias Lauer, Unterboehringen (DE)

(21) Appl. No.: 15/255,174

(22) Filed: Sep. 2, 2016

(30) Foreign Application Priority Data
Sep. 2, 2015 (DE) 10 2015 114 659.2

(51) Int. Cl. D01H 4/12; F16M 13/02

(52) U.S. Cl. CPC D01H 4/12; F16M 13/02

(57) ABSTRACT

A support disk for a suspension for a spinning rotor (2) of an open-end spinning device features a base body (8) and a thrust ring (9) with a running surface (10) attached on an outer circumference of the base body (8), whereas the running surface (10) has a crowned outer contour in the axial section. The running surface (10) features at least two partial sections (11), between which at least one groove-shaped recess (12, 14, 16) is formed. A suspension for a spinning rotor (2) of an open-end spinning device contains support disks (3) arranged in pairs forming a wedge slit, whereas the spinning rotor (2) can be mounted with its shaft (1) in the wedge slit, and whereas at least one of the support disks (3) is formed as described above.

The present invention relates to a support disk for a suspension for a spinning rotor of an open-end spinning device, whereas the support disk features a base body and a thrust ring with a running surface attached on an outer circumference of the base body, whereas the running surface has a crowned outer contour in the axial section. Furthermore, the invention relates to a suspension for a spinning rotor of an open-end spinning device with support disks arranged in pairs forming a wedge slit, whereas the spinning rotor can be mounted with its shaft in the wedge slit.

Suspensions for a spinning rotor of an open-end spinning device, whereas the shaft of the spinning rotor is located in wedge slits formed in/by support disks, are well-known in the state of the art. Thereby, the support disks are mounted on both sides of the shaft with common axes. So that a tangential belt driving a spinning rotor also produces an axial thrust acting on the shaft, the axes of the support disks are inclined against each other and against the shaft. Based on the inclined arrangement of the support disks and the high rotational speeds during the operation of the spinning rotor, a highly non-uniform, punctiform load of the running surfaces and a correspondingly high heat load arise. In order to reduce the signs of wear resulting from this, DE 28 01 693 A1 proposes support disks, the running surfaces of which are slightly crowned and smoothed. Thereby, contact points with the shaft are to be shifted more to the center of the running surfaces, such that the arising loads can be distributed from there equally on both sides.

The task of the present invention is to provide support disks with which the wear of the running coating is reduced even further.

The task is solved by a support disk and a suspension for a spinning rotor with the characteristics of the independent claims.

A support disk for a suspension for a spinning rotor of an open-end spinning device with a base body and a thrust ring attached to the outer circumference of the base body is proposed. Thereby, for this invention, it is irrelevant whether the outer circumference of the base body and thus the inside of the thrust ring are provided smooth or with contours.

The base body typically features a rotationally symmetrical outer contour, and is preferably essentially cylindrical. However, it may also assume special shapes; for example, it may feature the already specified contours on the outer circumference and/or may feature spokes and/or may be slightly curved outwards, in order to reduce air turbulence.

The thrust ring features a running surface, which has an outer contour crowned in the axial section of the support disk. Thereby—as described above—the contact point of the running surface with the shaft of the spinning rotor is moved more towards the center of the running surface, and signs of wear are consequently reduced. In accordance with the present invention, an axial section is understood to be each section through the support disk, the section plane of which contains the axis of rotation of the base body.

In accordance with the invention, the running surface features at least two partial sections, between which at least one groove-shaped recess is formed.

The at least one groove-shaped recess can be achieved in that a preferably circumferential groove is arranged between the two partial sections.

The specified groove may have different shapes, in particular rectangular, trapezoidal, or at least approximately V-shaped. In this case, a V-shaped groove is particularly advantageous, since, with its good surface area and thus good cooling performance, it features the highest load-bearing capacity.

The at least one groove-shaped recess may be achieved particularly advantageously in that the at least two partial sections are provided with outer contours that are shaped differently from one another. The groove-shaped recess is then formed by the direct abutment of the two differently shaped partial sections. For example, a partial section may be provided with a crowned outer contour, while the other partial section features a—viewed in a longitudinal cut—flat outer contour.

However, it is particularly advantageous if each of the at least two partial sections is provided with a crowned outer contour for itself. The groove-shaped recess may then in turn be formed by the direct abutment of the two different crowned partial sections.

Likewise, however, a groove may deepen the groove-shaped recess formed by the direct abutment of the two differently shaped partial sections.

Through the groove-shaped recess, the surface of the running surface and thus the convection surface responsible for cooling are enlarged. Consequently, owing to the better cooling, the heat load of the support disk is reduced, such that the early fatigue of the material of the running coating can be avoided. In addition, if each of the at least two partial sections is provided with a crowned outer contour for itself, despite the inclined axis of the support disks, two contact points of the shaft with the running surface arise. If, during operation, the spinning motor is then pushed into the wedge slit by the tangential belt, due to the two contact points, an enlarged contact surface and a highly uniform load of the running coating across its width arise, which further reduces the heat load and the wear of the running coating. Thereby, it has been found out that, despite the enlarged contact surface, only a slight increase in the flexing action in the running coating arises, such that, based on the uniform load on the running coating, the heat load as a whole is reduced.

In order to prevent the formation of cracks in the thrust ring, it is advantageous to round the groove-shaped recess or the groove base in a concave manner. It is likewise advantageous to round in a convex manner sharp edges in the profile of the thrust ring, in particular a transition existing between the running surface and the at least one groove, in order to reduce wear at such points.

In order to better distribute the contact points or surfaces on the running surface, it is advantageous to provide the at least two partial sections with at least two different, crowned outer contours and/or to arrange the at least two partial sections in such a manner that they feature at least two outer contours of different heights in the axial section. In the event that the outer contours in the axial section correspond to a circular arc, the different, crowned outer contours can be realized by different radii of curvature of the circular arcs. For the outer contours of different heights, the center of curvature of the circular arcs may be selected in different distances from the axis of rotation of the support disk. In both cases, through the better distribution that is achieved of the contact points or surfaces on the running surface, the heat load is also uniformly distributed, which prolongs the service life of the support disk.

It is also advantageous to design the running surface such that it features a per se wider contact surface and thus a heat load that is distributed on a wider area. This can be achieved in that the at least two partial sections form a running surface inclined relative to the axis of the support disk. For an arc-shaped outer contour of the at least two partial sections in the axial section, this means that the center of curvature of the circular arc is moved from the center of the support disk or the running coating, as the case may be, in the axial direction.

It is particularly advantageous if each of the at least two partial sections has the same width. At that point—in particular in combination with uniformly distributed contact points or surfaces and the uniformly distributed heat load as a result of this—a uniform heat dissipation arises, which has proven to be particularly gentle for the material.

The width of the support disks is advantageously between 4 mm and 10 mm, particularly advantageously between 6 mm and 8 mm and in particular between 6.5 mm and 7.5 mm. With respect to the other dimensions of the spinning rotor and the diameter of the support disk, such widths have turned out to be the best compromise between heat load, contact surface and handling.

It is further advantageous if a crowned outer contour of the running surface features a radius of curvature. If the two partial sections are provided with a common crowned outer contour, the radius of curvature preferably amounts to 7 to 13 times the width of the support disk. However, if each of the at least two partial sections is provided with a crowned outer contour that features a radius of curvature for itself, the radius of curvature of each partial section preferably amounts to 1.2 to 1.7 times the width of the support disk.

Further, a suspension for a spinning rotor of an open-end spinning device is proposed. This suspension features support disks arranged in pairs, which form a wedge slit. The spinning rotor may then be mounted with its shaft in the specified wedge slit. Thereby, in accordance with the invention, at least one of the support disks is formed as described above. Thus, the support points of the shaft of the spinning rotor are shifted in the direction of the center of the running surface of the support disks, and the heat load of the support disks is reduced owing to the groove-shaped recess.

Further advantages of the invention are described in the following embodiments. The following is shown:

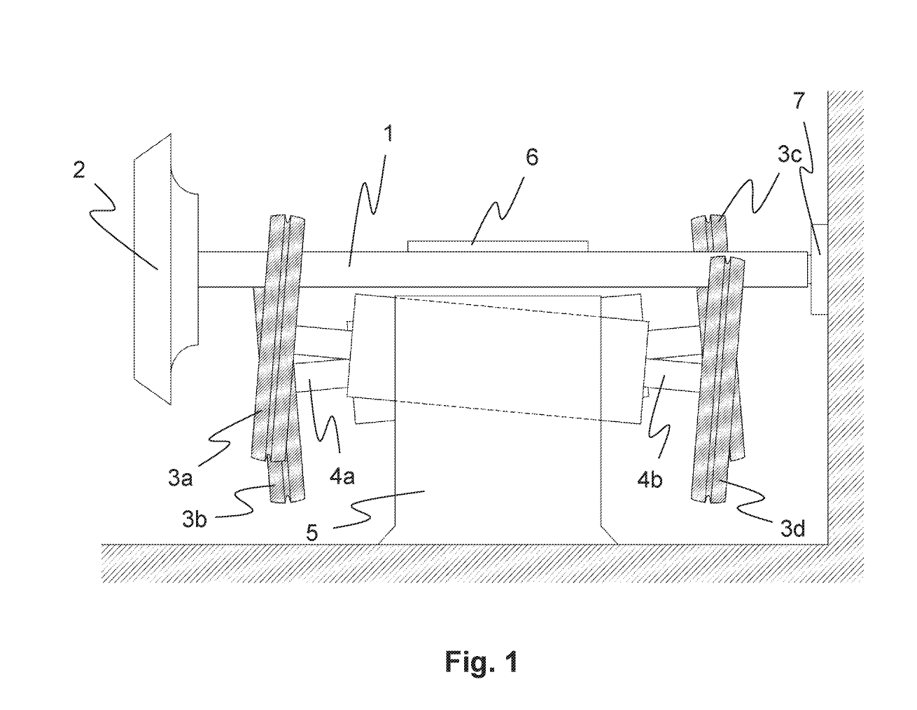

FIG. 1 a side view of a spinning rotor of an open-end spinning device together with a suspension,

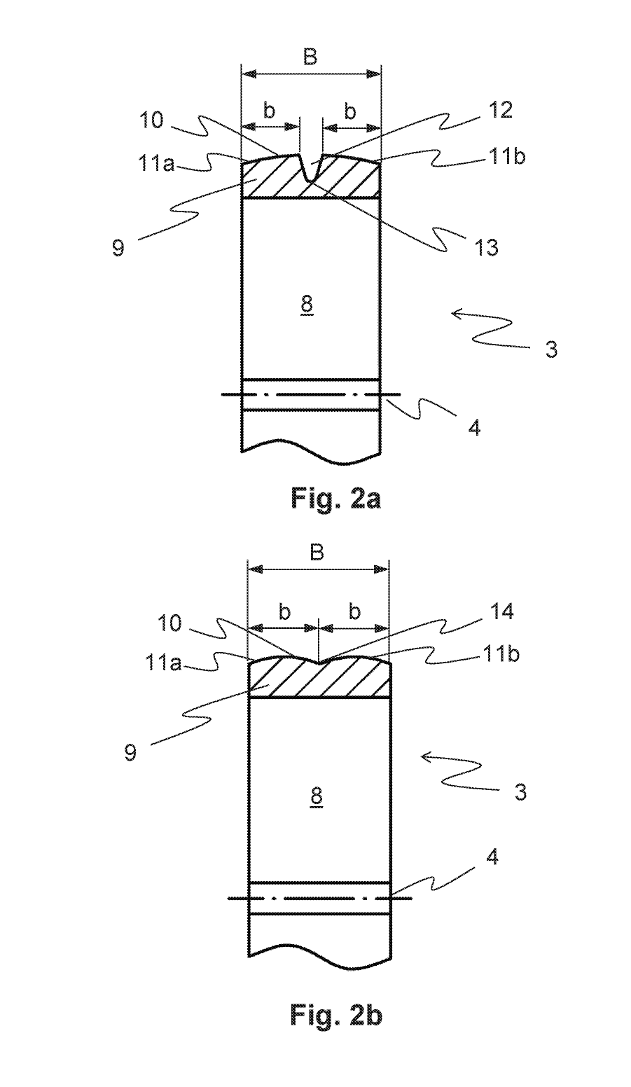

FIG. 2a a broken away, schematic sectional view of an embodiment of a support disk,

FIG. 2b a broken away, schematic sectional view of an additional embodiment of a support disk,

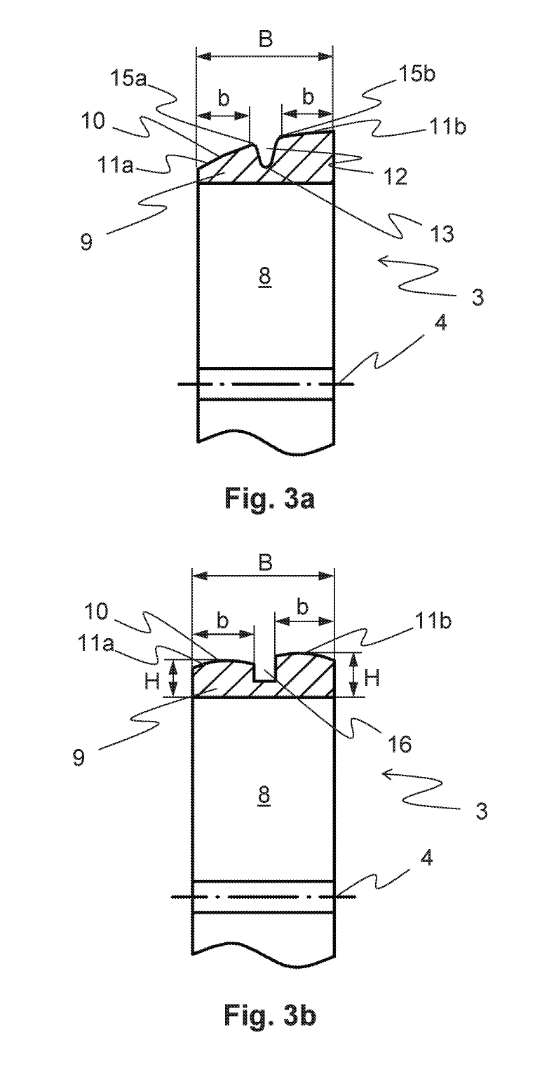

FIG. 3a a broken away, schematic sectional view of an additional embodiment of a support disk, and

FIG. 3b a broken away, schematic sectional view of an additional embodiment of a support disk.

As shown in FIG. 1, the shaft 1 of a spinning rotor 2 of an open-end spinning device is located in wedge slits formed by support disks 3. Thereby, the support disks 3 are mounted on both sides of the shaft 1, in each case with common axes 4 in a bearing block 5. The axes 4 are inclined against each other and against the shaft 1 such that a tangential belt 6 driving the shaft 1 exerts on the shaft 1 an axial thrust in the direction of a pivot bearing 7. The particular formation of the running surface 10 of the support disks 3 is only indicated in this figure, and is shown in more detail in the following figures. Thereby, in order to improve clarity, the crowned outer contour in the axial section is shown in an exaggerated manner.

FIG. 2a shows a cross-section of a first embodiment of a support disk 3. A thrust ring 9 with a running surface 10 is attached to the base body 8. The running surface 10 has a crowned outer contour in the axial section, such that, in an advantageous manner, a contact of the running surface 10 with the rotor shaft 1 in a central area of the running surface 10 is formed, from which the heat that arises can be evenly distributed.

In addition, the thrust ring 9 features a V-shaped groove 12, which divides the running surface 10 into two partial sections 11a, 11b. Thereby, the groove 12 increases the surface of the running surface 10 and thus improves cooling. At the same time, on the basis of the groove 12, in an advantageous manner, two contact points with the shaft 1 and thus an increased contact surface arise, which leads to a more uniform heat load and a more uniform wear of the running surface 10. Thereby, the groove base 13 of the groove 12 is rounded in a concave manner, in order to prevent the formation of cracks in the thrust ring 9.

The support disk 3 preferably features a width B between 6.5 mm and 7.5 mm, which also contributes to a low heat load of the running coating. In addition, with the shown embodiment, each of the two partial sections 11a, 11b features the same width b.

The two partial sections 11a, 11b of the support disk 3 of FIG. 3a feature a common crowned outer contour with a radius of curvature. Thereby, the radius of curvature advantageously amounts to approximately 10 times the width B of the support disk 3.

With the following descriptions of the alternative embodiments shown in FIGS. 2b, 3a and 3b, the same reference signs are used for characteristics that are identical and/or at least comparable in their structure and/or mode of action compared to the first embodiment shown in FIG. 2a. To the extent that they are not explained once again in detail, their structure and/or mode of action correspond to the structure and/or mode of action of the characteristics already described above.

With the embodiment shown in FIG. 2b, each of the two partial sections 11a, 11b of the running surface 10 features a crowned outer contour for itself. As a result, completely without a separate groove, a groove-shaped recess 14 arises. Here as well, the groove-shaped recess 14 causes an enlargement of the surface of the running surface 10 and thus improved cooling. Based on the crowned outer contour of each of the two partial sections 11a, 11b for itself, in turn, an advantageous, increased contact surface with a uniform heat distribution and more uniform wear arises.

Here as well, the crowned outer contours of the two partial sections 11a, 11b feature a radius of curvature. Thereby, the radius of curvature of each of the two crowned outer contours advantageously amounts to approximately 1.3 to 1.5 times the width B of the support disk 3. However, in deviation from the presentation shown here, it is also possible to provide each of the outer contours of the two partial sections 11a, 11b with different radii of curvature.

FIG. 3a now shows a support disk 3, with which the running surface 10 formed by the partial sections 11 is inclined relative to the axis 4 of the support disk 3. Thereby, even with a stronger set suspension, a contact point or a contact surface between the running surface 10 and the shaft 1 of the spinning rotor 2 in the area of the center of the running surface 10 can be also achieved. In addition, this embodiment features a V-shaped groove 12, the groove base 13 of which is rounded in a concave manner, and convexly rounded transitions 15a, 15b between the running surface 10 and the groove 12. Such convexly rounded transitions 15a, 15b are preferable to sharp edges, since a selective wear at the sharp edges is thereby reduced.

As the last embodiment, FIG. 3b shows a support disk 3 with a thrust ring 9, the running surface 10 of which features two partial sections 11a, 11b, each of which is provided with a crowned outer contour for itself. Thereby, unlike the embodiment of FIG. 2b, the outer contours of the two partial sections 11a, 11b feature heights different from each other. Thereby, in contrast to outer contours of the same height, the contact points for the shaft 1 of the spinning rotor 2 are distributed uniformly strongly on the two partial sections 11a, 11b, which distribute both the heat load and the wear more evenly on the partial sections 11a, 11b. In this embodiment, the thrust ring 9 also features a rectangular groove 16. In contrast to a V-shaped groove, the rectangular groove 16 is less robust, but features a greater surface area and thus improved cooling properties.

This invention is not limited to the illustrated and described embodiments. Variations within the scope of the claims, just as the combination of characteristics, are possible, even if they are illustrated and described in different embodiments.

### LIST OF REFERENCE SIGNS

1 Shaft
2 Spinning rotor
3 Support disk
4 Axis
5 Bearing block
6 Tangential belt
7 Pivot bearing
8 Base body
9 Thrust ring
10 Running surface
11 Partial sections of the running surface
12 V-shaped groove
13 Groove base
14 Groove-shaped recess
15 Transition between running surface and groove
16 Rectangular groove
B Width of the support disk
b Width of the partial section
H Height of the outer contour of a partial section

1. Support disk for a suspension for a spinning rotor (2) of an open-end spinning device, whereas the support disk (3) features a base body (8) and a thrust ring (9) with a running surface (10) attached on an outer circumference of the base body (8), whereas the running surface (10) has a crowned outer contour in the axial section, characterized in that the running surface (10) features at least two partial sections (11), between which at least one groove-shaped recess (12, 14, 16) is formed.

2-12. (canceled)
